(19) United States
(12) Patent Application Publication
(10) Pub. No.: US 2011/0252678 A1
(43) Pub. Date: Oct. 20, 2011

(54) METHOD, APPARATUS AND SYSTEM FOR CONSTANT LED NIGHT BRIGHTNESS BASED ON DAYTIME SOLAR CHARGING

(76) Inventors: Dale Jones, Shell Beach, CA (US); Joel Yang, Singapore (SG)

(21) Appl. No.: 13/084,231

(22) Filed: Apr. 11, 2011

Related U.S. Application Data
(60) Provisional application No. 61/342,379, filed on Apr. 12, 2010.

(51) Int. Cl. G09F 13/04; F21L 4/08; G09F 13/16

(52) U.S. Cl. 40/572; 40/541; 362/183

(57) ABSTRACT

A street sign method, system and apparatus includes at least one translucent sign face, a solar photovoltaic panel system for generating electrical energy from sunlight, a rechargeable battery system for storing the electrical energy during the day, at least one Light Emitting Diode (LED) powered by the electrical energy stored in the rechargeable battery system, and a control circuit powered by the rechargeable battery system and configured to operate the at least one LED to illuminate the at least one sign face. The control circuit is configured to calculate an amount of electrical power that can be supplied from the rechargeable battery system to the at least one LED so that said the at least one LED operates at a relatively constant level of LED light output brightness during substantially the entire night time hours based on solar energy supplied to the rechargeable battery system during the previous daytime hours. The street name sign is mountable to a post or pole.

### CROSS-REFERENCE TO RELATED APPLICATION

This is a regular utility application of provisional application Ser. No. 61/342,379, filed Apr. 12, 2010, the contents of which are expressly incorporated herein by reference.

### FIELD

This application generally relates to street signs, and more particularly, to methods, apparatus and systems for illumination of a street sign having translucent sign faces with one or more light emitting diodes (LEDs), which operate at relatively constant LED brightness during all the night time hours from electric energy stored in a rechargeable battery based on electrical energy provided with a solar photovoltaic panel system powered from sunlight during the previous daytime hours. An exemplary street sign is a street name sign typically located at street corners.

### BACKGROUND

Street name signs provide the name of the street and assist motorists who are looking for a particular address or location when they are driving in an unfamiliar area. In daytime, reading the name on the street name signs does not present any particular problem. However, at night or in the dark and depending on weather conditions, the headlights from the motor vehicle are generally aimed parallel to the surface of the road, and therefore may not sufficiently illuminate street name signs, because street name signs are generally mounted about 10 ft to 14 ft. above the surface of the road.

Light-emitting diodes, or LEDs, can be used to illuminate street name signs. LEDs have become an increasingly popular means of providing illumination in such widely varied applications including traffic signs, automobile brake lights, traffic signals, hand-held electronic devices and electronic message boards. LEDs provide illumination with an electrical energy saving typically more than 90% compared with conventional incandescent light bulbs. LEDs also have an operating lifetime typically more than about 10 years. LEDs typically operate at direct current (DC) voltages which depend on the color of the LED and the forward voltage rating of the LED. For example, red and yellow LEDs typically operate at about 2.1 to 3.4 VDC and white LEDs typically operate at about 3.0 to 4.3 VDC.

U.S. Pat. Nos. 6,693,556 and 6,943,698; U.S. Patent Application Publication 2008/0246416; and pending U.S. Application Serial No. 13/073,442, filed Mar. 28, 2011, all of which are expressly incorporated by reference herein and have been issued and invented or developed by one or more of the co-inventors of the present invention, disclose methods and apparatus for improving the performance of light emitting diodes (LEDs) which are provided with electric power by means of solar photovoltaic panel systems used for recharging batteries so that the LEDs can operate effectively in both day and night conditions.

### SUMMARY

To increase the visibility of traffic signs, the current supplied to one or more LEDs from a variety of different types of power supply sources is controlled. For example, LEDs cannot be adequately controlled simply by providing a constant DC supply voltage. One reason is that in most cases, each LED differs from the other LEDs because each LED is ranked according to its specific forward voltage parameter. The forward voltages of typical LEDs can vary by +/−20% or more. If the forward voltage of an LED is exceeded by as little as +5%, the LED can quickly burn out because the current through the LED would then increase in a non-linear fashion as forward voltage is increased only slightly.

According to one aspect of the disclosure, an apparatus, system and method for reducing street name sign visibility problems includes providing street name signs with translucent name sign faces which are automatically illuminated from dusk to dawn during all the night time hours. Illumination of the one or more translucent sign faces on the street name sign is provided by one or more light emitting diodes (LEDs) which are provided with electrical energy from a rechargeable battery located inside the illuminated street name sign. In addition, the illuminated street name sign has a solar photovoltaic panel system located along the top surface which captures solar energy during daylight hours and thereby is able to recharge the battery system.

According to another aspect of the disclosure, an apparatus, system and method includes providing relatively constant night time LED brightness output, which is reflected to illuminate one or more translucent sign faces such that the brightest area of illumination does not exceed about three (3) times the brightness of the dimmest area of illumination. The present disclosure also provides details of a control circuit which monitors the total amount of solar charge being supplied to the battery from solar photovoltaic panels during the daytime hours and then adjusts the level of current to be provided to the LEDs from the battery during the upcoming night time hours, thereby providing a relatively constant level of LED brightness and illumination of the translucent sign faces regardless the ambient weather conditions during the previous daytime hours. Methods are also disclosed regarding mounting the illuminated solar street name sign onto posts or poles either as single street name signs or double-mounted signs positioned at right angles to each other and positioned as appropriate at cross-street locations.

According to another aspect of the disclosure, to enhance the usefulness of LEDs for the purpose of increasing the visibility of traffic signs, the current supplied to one or more LEDs from a variety of different types of power supply sources is controlled. Accordingly, a method, apparatus and system is disclosed for adjusting the current supplied to one or more LEDs on an illuminated street name sign to thereby remain at a relatively constant LED light output brightness all during the night time hours, regardless of the amount of solar energy captured during the previous daytime hours. This means that in winter weather conditions with overcast skies and shorter daytime hours, the LED illumination might be reduced, but would still remain relatively constant during all the longer night time hours.

According to another aspect of the disclosure, power supply sources include batteries, such as rechargeable batteries which can be recharged using solar photovoltaic panels, or fuel cells, such as micro fuel cells using the direct methanol fuel cell (DMFC) process. Other power supply sources include fuel cells, which can typically be recharged using methanol or other alcohol mixtures. Solar photovoltaic panels typically utilize crystalline silicon cells connected in series to obtain sufficiently high voltages for efficient charging of rechargeable storage batteries. Electric energy is then withdrawn from the rechargeable storage batteries by a control circuit to provide electrical power for properly operating the one or more LEDs.

According to one aspect of the disclosure, a control circuit regulates the voltage and the current provided to the one or more LEDs to ensure proper operation of the LEDs during all the night hours based on energy supplied to the battery during the previous daytime hours. The control circuit is also capable of providing the proper voltage and current to the one or more LEDs to ensure proper operation of the LEDs over a relatively wide range of battery supply voltages. The same type of control circuit can be used if the power supply system includes use of a DMFC fuel cell or an externally-supplied source of electrical energy (such as 120 VAC or 240 VAC), rather than a battery which can be recharged during daylight hours using a solar photovoltaic panel system.

As previously described. LEDs may not be properly operated simply by supplying a fixed DC voltage. The DC current supplied to one or more LEDs may have to be properly controlled to avoid burning out the LEDs if the current is too high, but also to provide adequate current to the LEDs (to assure adequate light output from the LEDs) over a reasonably wide range of power supply voltages. For example, if one or more LEDs are to be operated from a fixed battery system, the battery voltage will decrease as the LEDs continue to be operated. According to another aspect of the disclosure, the battery system includes a rechargeable battery connected to a solar photovoltaic panel, which recharges the battery during the daytime when there is adequate ambient light intensity. At night or in dim ambient lighting conditions, the battery system is then used to operate one or more LEDs as determined by the Control Circuit used as an integral part of the present invention. According to another aspect of the disclosure, when the voltage output from the photovoltaic solar panel system drops to a level near zero, this then signals the onset of the night hours and the control circuit then subsequently turns on the one or more LEDs. Other types of sensor signals could optionally be used to provide on-off control of the LEDs, such as photocell sensors, photodiodes, phototransistors, photothyristors and light-activated silicon-controlled rectifiers (LASCRs).

Aspects of the disclosure relate to an enhanced visibility street name sign having one or more LEDs which are operated from a battery-powered control circuit, wherein the battery receives electrical power from a solar photovoltaic panel system during the daytime, and wherein the control circuit monitors the total amount of solar energy supplied to the battery during the previous daytime hours and calculates the optimum or near optimum amount of electric power which can be supplied from the battery to the LEDs such that the LEDs operate at a relatively constant level of LED light output brightness all during the upcoming night time hours.

According to another aspect, the disclosure includes the use of a control circuit which provides a relatively constant level of LED light output brightness all during the night time hours. The control circuit accomplishes this by recording the amount of solar energy provided to the battery during the previous daytime hours, and then calculates the optimum amount of energy that the battery can then provide to the LEDs during all the upcoming night time hours. The control circuit automatically repeats this process each 24 hour period. The LEDs are thereby always illuminating the translucent street name sign faces during the night time hours, regardless how little or how much solar energy was provided to the battery during the previous daytime charging cycle.

According to another aspect of the disclosure, the control circuit includes a circuit mounted on a printed circuit board (PCB) and generally includes a variety of digital and analog circuit components. The control circuit records the amount of solar energy provided from sunlight provided from the solar panels for battery charging. This is accomplished with a digital energy counter that records the solar energy charge to the battery each time interval (typically one second is used) and totalizes the result at the end of the daylight hours. The daylight hours end whenever the voltage output from the photovoltaic solar panel system drops below a predetermined threshold which is near zero volts. The night time hours are then determined by subtracting the number of the previously-determined daytime hours from 24 hours for the complete day and night cycle of hours. This totalized battery charge result is then used for calculating the optimum level of electrical energy that can be consumed by the one or more LEDs from the battery all during the upcoming night time hours. This control circuit method ensures that the one or more LEDs will continue to operate during all the night time hours at a relatively constant level of LED light output brightness which is determined at the beginning of dusk at the start of each night time cycle. This optimum or near optimum amount of electrical energy is calculated based on how much solar energy has been supplied to the battery during the previous daytime hours, and utilizes the number of upcoming night time hours required for the LEDs to operate during the entire night. For example, in sunny weather conditions, the one or more LEDs on the illuminated street name sign will operate with higher levels of LED brightness and in overcast winter weather, the same LEDs will operate all night long but with lower levels of LED brightness.

According to another aspect, a method, apparatus and system is disclosed for mounting the illuminated street name sign securely on the top of a post or pole using a central rod with a threaded nut on top that provides a secure and vandal-resistant mounting system for the illuminated street name sign when the nut is tightened.

### BRIEF DESCRIPTION OF THE DRAWINGS

The various embodiments of the present methods, systems, and devices will now be discussed in detail with an emphasis on highlighting the advantageous features. These embodiments depict the novel and non-obvious apparatus shown in the accompanying drawings, which are for illustrative purposes only. These drawings include the following figures, in which like numerals indicate like parts.

FIG. 1 is a perspective view of a solar LED street name sign according to one embodiment.

FIG. 2 is an enlarged view of area 2 of FIG. 1.

FIG. 3 is a cross sectional view of the solar LED street name sign of FIG. 1.

FIG. 4 is a perspective view of the solar LED street name sign of FIG. 1 shown mounted to a post.

FIG. 5 is a partial perspective view of a LED and a reflector assembly of a solar LED street name sign according to one embodiment.

FIG. 6 is a partial perspective view a solar LED street name sign according to one embodiment showing a removable LED insert piece.

FIG. 7 is a partial cross sectional view of a solar LED street name sign according to one embodiment.

FIG. 8A is a cross-sectionals view of an end cap of a solar LED street name sign according to one embodiment.

FIG. 8B is partial side cross-sectional view of the end cap of FIG. 8A.

FIG. 8C is a cross-sectional view of the end cap of FIG. 8B taken at section A-A of FIG. 8B.

FIG. 8D is a perspective view of an end cap of a solar LED street name sign according to one embodiment.

FIG. 9 is a perspective view of a solar panel and a removable battery system of a solar LED street name sign according to one embodiment.

FIG. 10 is a control circuit block diagram for a solar panel of a solar LED street name sign according to one embodiment.

FIG. 11 is an energy pulses generator circuit for a solar ED street name sign according to one embodiment.

FIG. 12 is a digital energy storage circuit for a solar LED street name sign according to one embodiment.

FIG. 13 is an energy digital to analog converter circuit for a solar LED street name sign according to one embodiment.

FIG. 14 is an energy scaler circuit for a solar LED street name sign according to one embodiment.

FIG. 15 is an LED driver circuit for a solar LED street name sign according to one embodiment.

FIG. 16 is an under voltage protection circuit for a solar LED street name sign according to one embodiment.

FIG. 17 is a day-hour counter circuit for a solar LED street name sign according to one embodiment.

FIG. 18 is a day-night automatic switching circuit for a solar LED street name sign according to one embodiment.

FIG. 19 is a post or pole mounting system for a solar LED street name sign according to one embodiment.

FIG. 20 is a partial cross-sectional view of the post or pole mounting system of FIG. 19.

### DETAILED DESCRIPTION

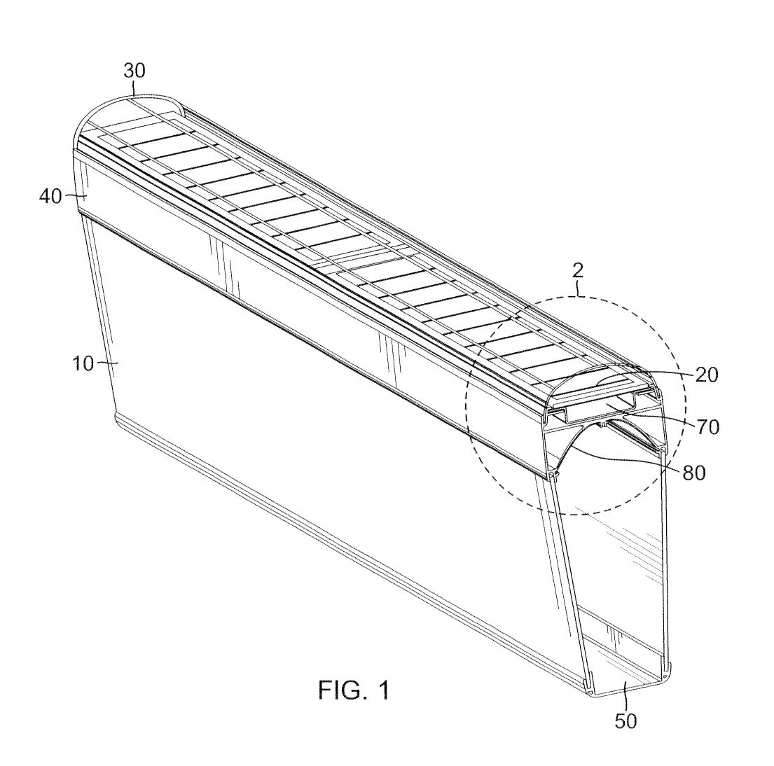

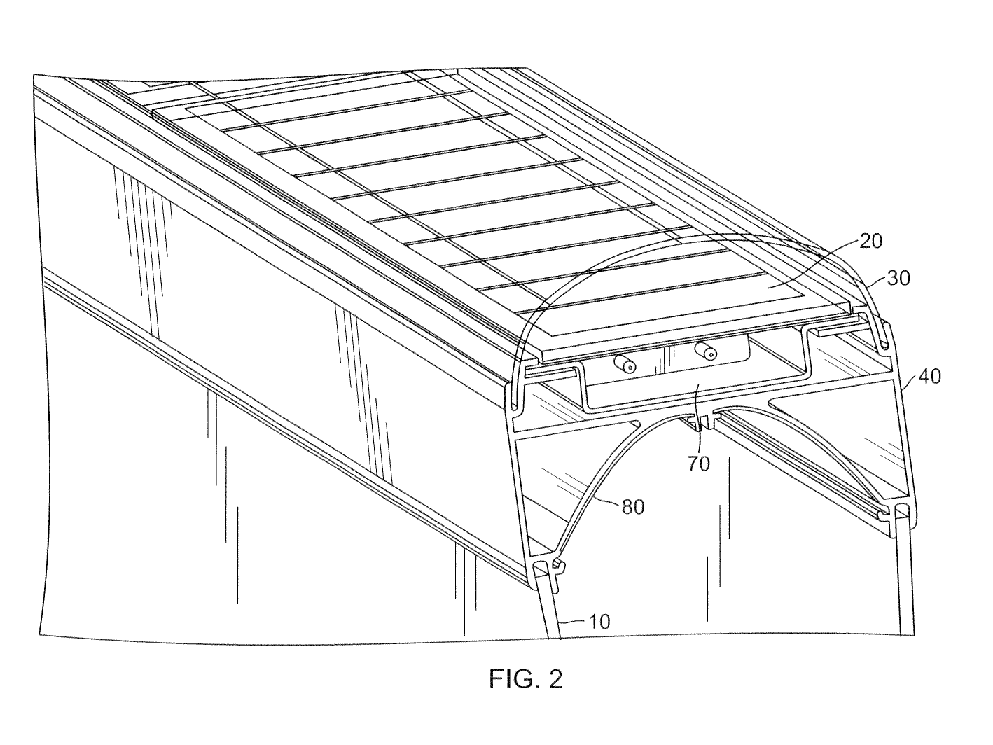

Turning now to FIGS. 1 and 2, perspective views of an illuminated street name sign according to one embodiment are shown. The illuminated street name sign has translucent sign faces 10, which can be located on one side or both sides of the street name sign. When the translucent sign faces are on both sides of the illuminated street name sign, occupants of motor vehicles can read the street name regardless of which direction they are driving along the street. The illuminated street name sign in FIG. 1 receives electrical power from one or more solar panels 20, located along the top surface of a top extrusion piece 40. The solar panels 20 are covered and protected by a curved transparent top cover 30, which is attached to and supported by the top extrusion piece 40. The translucent sign faces 10 are mounted between the top extrusion piece 40 and a bottom extrusion piece 50. The translucent sign faces 10 may be provided with white colored sign name lettering when illuminated, and the background color may be green or any other desired color when illuminated. The lettering and the background, however, can be any color as long as the colors do not hinder the function of the street name sign. The sign name lettering may be cut out from reflective sheeting material used for the background color, such as green, and the pre-cut reflective sheeting material may be then affixed to a white-colored translucent sign face to complete installation of the street name lettering.

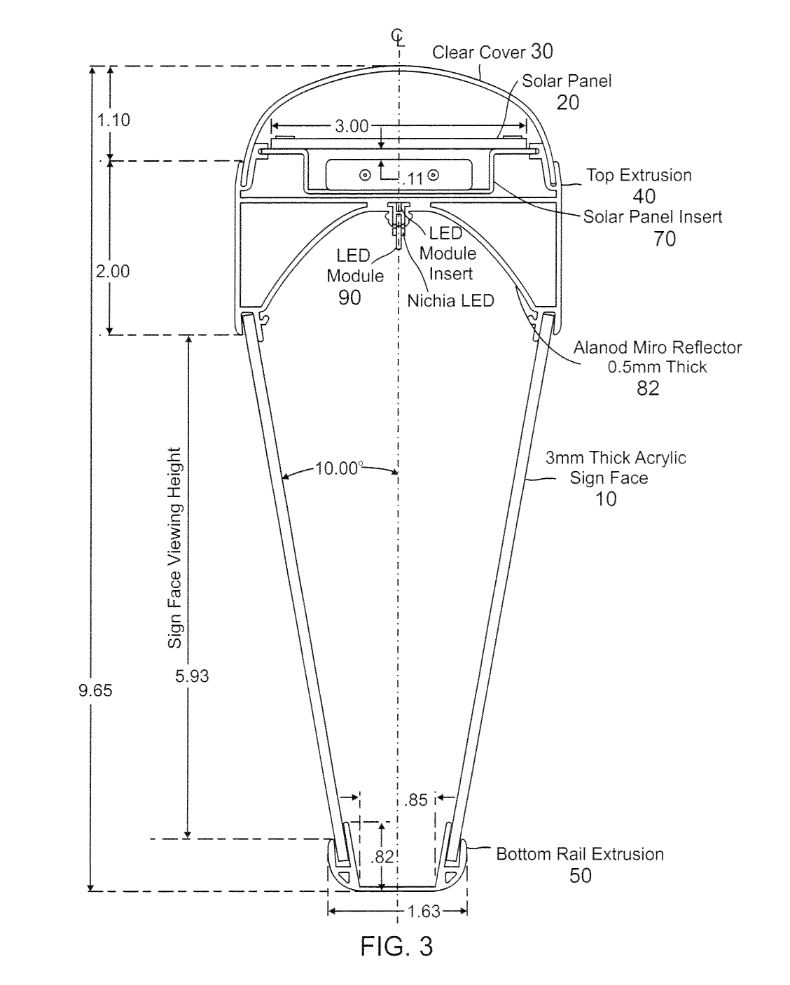

According to one embodiment shown in FIG. 3, the street name sign includes a clear plastic top cover 30, the illuminated street name sign faces 10, the top extrusion piece 40, the bottom extrusion piece 50, the solar panel 20, a solar panel insert 70, which includes the rechargeable battery system 74 located under the solar panel 20, and a reflective aluminum material 82, which forms a curved reflective surface 26 and is mounted underneath a curved bottom surface of the top extrusion piece 40. Also shown in FIG. 3 is a LED module system 90, which can be removed and/or replaced by removing one or both end caps 60 of the street name sign.

The transparent top cover 30, mounted into slots along the length of the top extrusion 40, protects the solar panels 20 from debris, bird droppings and water staining, which would otherwise decrease the amount of solar charging that can be provided from the solar panel system 20 to the battery system 74. In one embodiment, the transparent top cover 30 is made from high strength clear plastic material, such as Lexan®, which can be an uncoated polycarbonate sheet. The tensile strength of Lexan® Type 9034, for example, is about 9,000 psi at the initial yield point, and the deformation under 4000 psi load at 158° F. has been measured to be only 0.30%.

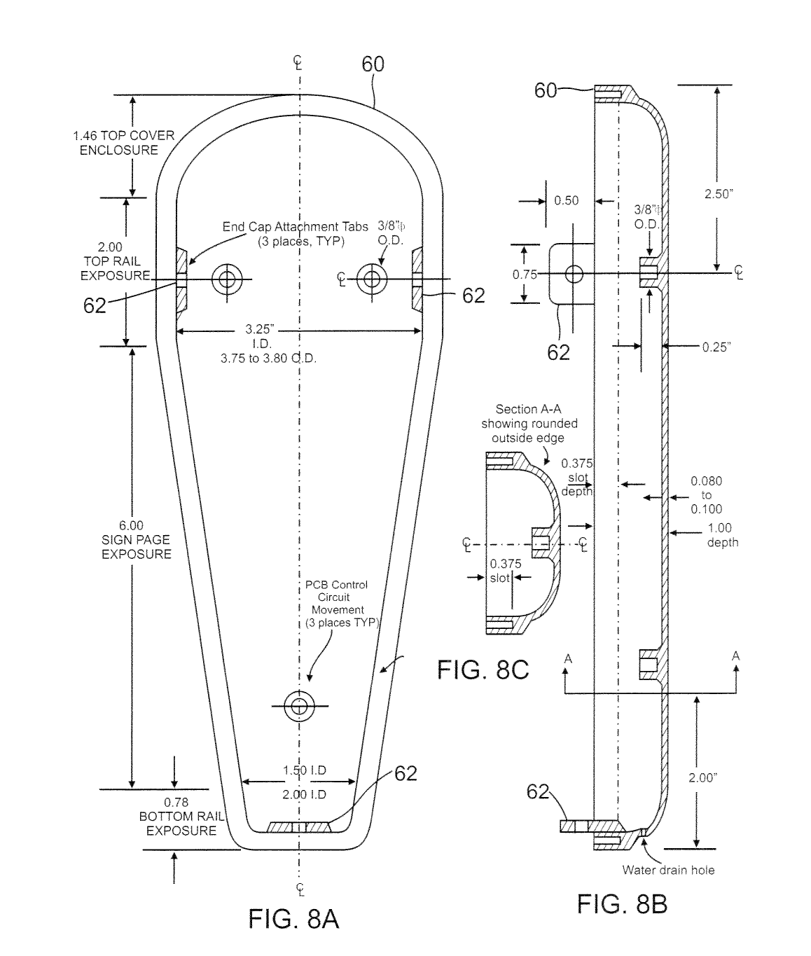

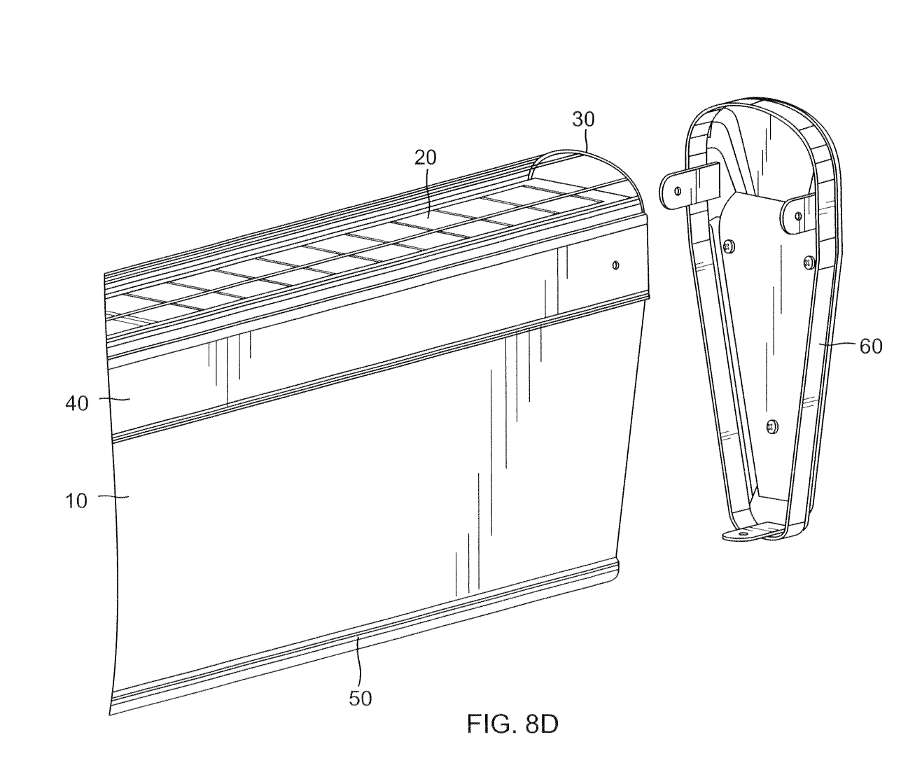

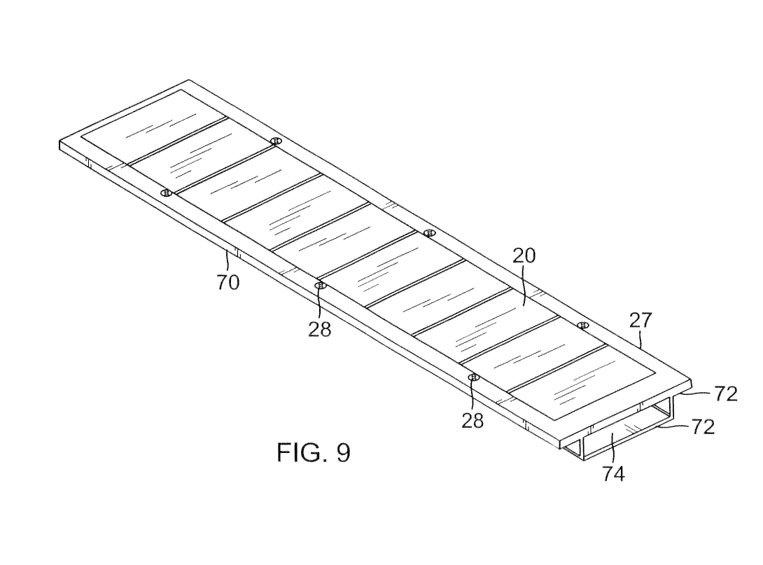

As shown in FIGS. 8A-8D, the illuminated street name sign is enclosed at the two ends by end caps 60, which also provide mechanical support and enhanced water resistance for the entire assembly and are attached using suitable mechanical screws which secure the end caps into the sidewalls of the top extrusion, 40 and the bottom extrusion 50. The end caps 60 may also be attached to the top extrusion 40 by other types of fastening devices or methods.

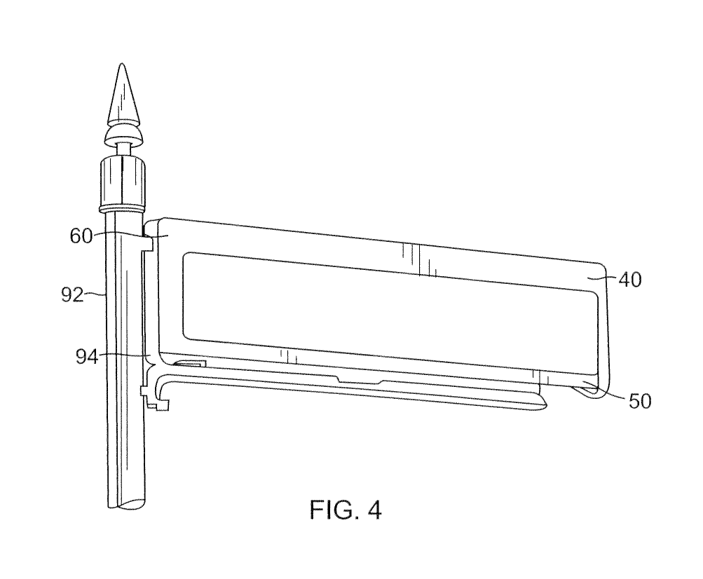

The street name sign is shown mounted to a mounting post 92 in FIG. 4. The street name sign in daylight hours is illuminated by the LEDs located inside the street name sign structure. The top and bottom extrusions 40 and 50, as well as the end caps 60 are shown in FIG. 4. Also indicated in FIG. 4 is a cantilever mounting bracket 94, and the mounting post 92, both of which are typical for street name sign installations.

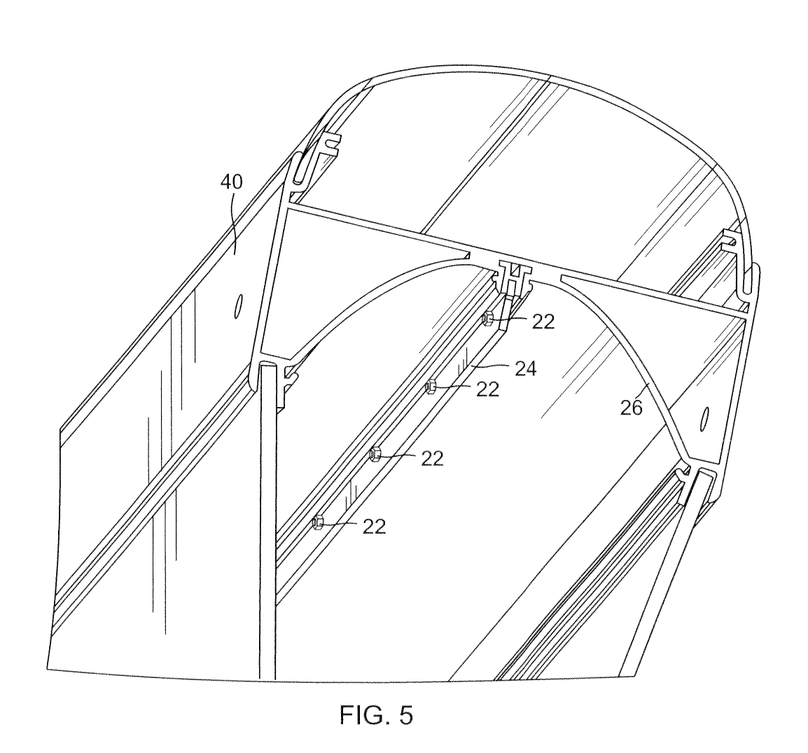

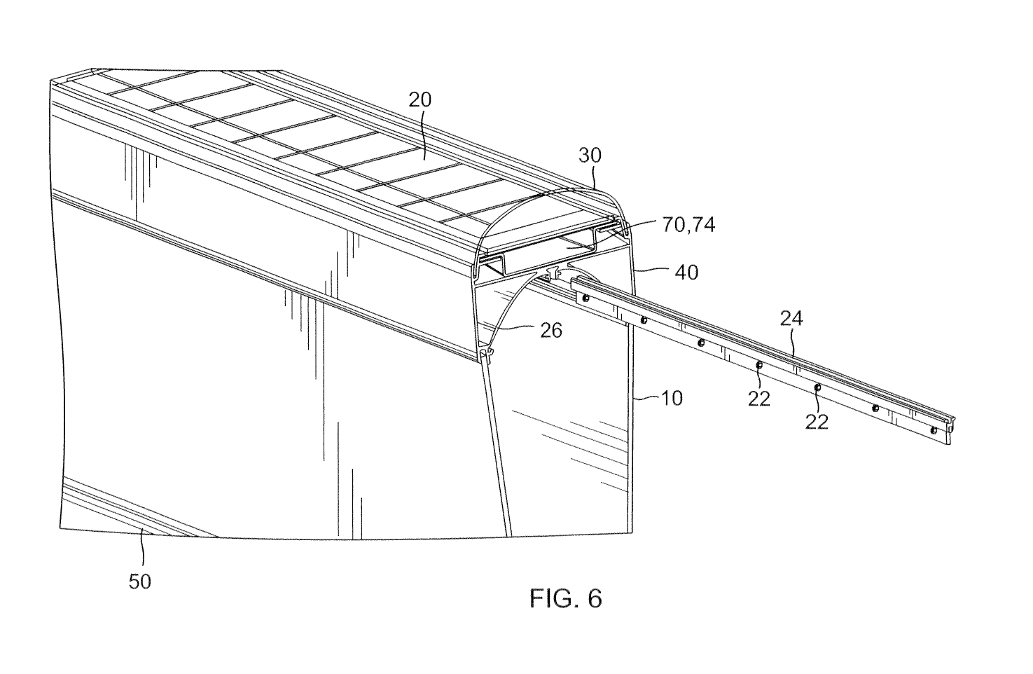

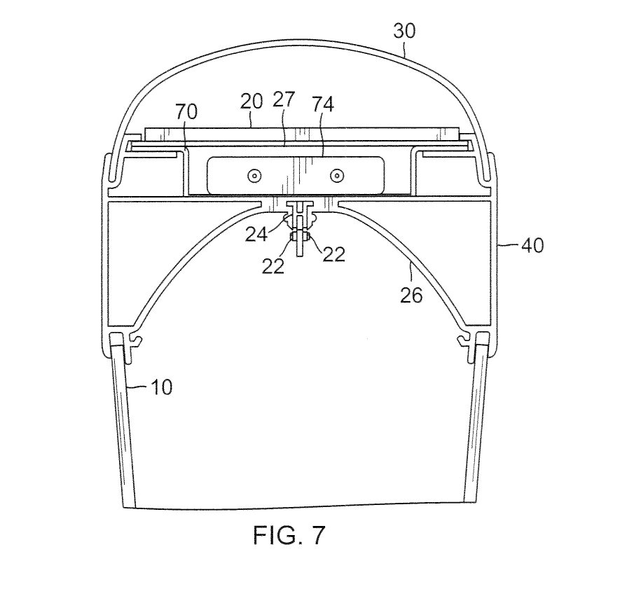

FIGS. 3, 5, 6 and 7 provide details showing the LEDs 22 according to one embodiment. These drawings show the arrangement of the curved reflector 26, which is arranged along the underside of the curved bottom surface 28 on the underside of the top extrusion piece 40. In FIG. 5, a perspective view of the curved reflective surface 26 illustrates the mounting configuration thereof along the curved bottom surface of the top extrusion piece 40, with the LEDs 22 arranged at intervals along the removable LED assembly 24. The LED assembly 24 may be a removable and can slide into or out from a slot located at the bottom centerline of the top extrusion piece 40. This detail is shown in FIGS. 6 and 7, which illustrate the method by which the LED assembly 24 with LEDs 22 can be installed or removed from the slot provided along the bottom centerline of the top extrusion piece 40. The LED assembly 24 may be made from any type of a removable part, for example, such as plastic or metal or PCB substrate or a combination thereof. In one embodiment, the LEDs 22 are located approximately 2 inches apart along the entire length of the street name sign assembly. However, the LEDs 22 can be located at any interval along the length of the street name depending on the physical and operational characteristics of the LEDs 22. Typically, surface-mounted white LEDs that are approximately 5 mm diameter can be used, as they are easily wave soldered to substrate material used to provide the special LED assembly 24 that can be installed or removed from the top extrusion piece 40.

A perspective view of the LEDs 22 and the curved reflective surface 26 is provided in FIG. 5, where the spacing between adjacent LEDs 22 is shown along with the approximate curvature of the reflective surface 26. In one embodiment, the output light from the LEDs 22 is reflected from the curved reflective surface 26, and thereby provides relatively uniform illumination of the translucent sign faces 10. In one embodiment, the output light from the LEDs 22 can be efficiently utilized to provide relatively uniform illumination of the translucent sign faces 10. The curved reflective surface 26 can be constructed from Alanod Miro 7 type aluminum sheeting or alternatively any other suitable type of reflective material. The reflected LED light should provide relatively uniform illumination of the translucent sign faces 10 with the brightest sign face areas being not more than about three (3) times brighter than the least brightest sign face areas when the illuminated street name sign is being observed from the street.

The light output from the LEDs 22 as shown in FIGS. 3, 5, 6 and 7 impinges on the curved reflective surface 26, and the reflected light is therefore directed downwards all along the inside surfaces of the translucent sign faces 10. The LEDs 22 may be positioned at about 2 inch intervals along the removable plastic part 24, and thereby provide a horizontal light beam output. This horizontal LED light output is then reflected from the curved aluminum reflective surface 26, thereby providing a high degree of uniform light illumination along the inside surfaces of the translucent sign faces 10.

In a preferred embodiment, the LEDs 22 are 5 mm diameter Nichia white LEDs designed for surface mounting on a PCB substrate. For example, the Nichia Model NSSWO64 type of surface mounted LED is natural white color rated 4600K to 5600K which provides about 1500 millicandella of light output and a surface brightness of about 100 Lux when supplied with about 20 mA current and operating at a preferred supply voltage of between about 3.0 VDC and 3.6 VDC.

The solar panel system 20 is also shown in FIGS. 6 and 7. The translucent sign faces 10 along with the top and bottom extrusions 40 and 50 are also shown in FIGS. 6 and 7. However, the cross-sectional views of the end cap design 60 is provided separately in FIGS. 8A-8C. As shown in FIGS. 6, 7 and 9, the removable solar panel assembly 70 slides in or out from the side grooves in the top extrusion piece 40. This solar panel assembly 70 includes the solar panels system 20 with solar cells mounted on a PCB plastic substrate 27 and attached to the metal frame 72 using countersunk flathead screws 28. The battery system 74 is located under the solar panel substrate 27. The solar panel assembly includes all the connecting wires and miniature polarized DC plugs and jacks which are required for connecting all of these parts together and interconnecting with the Control Circuit located in one of the two end caps 60.

Another embodiment is illustrated in FIGS. 3 and 8A-8C, which provide views of internal parts, with exemplary dimensions expressed in inches. The translucent sign faces 10 are located along the sides of the street name sign and provide an illuminated visible sign face area of about 6×30 inches on each side. The solar panel system 20 includes the battery system 74 and the removable solar panel assembly 70, which slides in or out from the top extrusion piece 40. The bottom extrusion piece 50 can be narrower than the top extrusion piece 40 and holds the bottom edges of the translucent sign faces 10, which are angled about 10 degrees downwards from vertical to thereby be aimed approximately directly towards oncoming motor vehicle traffic. The top extrusion piece 40 is nearly 2 inches high and the bottom extrusion piece 50 is about 1 inch high. The illuminated street name sign is powered from a rechargeable battery system 74 located in a side-by-side arrangement underneath the solar panel substrate 27 as shown in FIG. 9.

In an embodiment having a visible sign name face size of about 6×30 inches, there may be about 28 pieces of LEDs with 14 pieces aimed toward one sign face and the other 14 pieces aimed towards the other sign face. As shown in FIGS. 8A-8C, the outside dimensions of the end caps 60 are approximately 3.8×10.3 inches in plan view and about 1.3 inches deep is side view. The three end cap attachment tabs 62 are approximately 0.5×1.0 inches, which extend from the periphery of the end cap 60 towards the top and bottom extrusion pieces 40 and 50. The inside volume of the illuminated traffic sign is hollow and the overall assembly is light weight and not cumbersome.

The dimensions for an embodiment of an illuminated street name sign, as illustrated in FIGS. 3 and 8A-8C, are shown in inches. In another embodiment, the outside dimensions of the complete illuminated street name sign assembly is approximately about 33 inches long, about 10.0 inches high, and about 3.8 inches at the widest part of the top extrusion piece 40.

The street name sign also includes a control circuit which is located in one of the end caps 60, which can be mounted using fasteners, machine screws, or the like at locations shown in FIG. 8D. The end caps 60 provide structural strength for the illuminated street name sign assembly, and are attached using fasteners, machine screws or the like, which pass into corresponding holes provided in the sidewalls of the top and bottom extrusion pieces 40 and 50. The end cap 60 includes a small hole used for plugging in a dummy DC plug, which disconnects the control circuit during storage or shipping, and is easily removed by the end user which then activates the control circuit and begins operating the LEDs 22 when there is darkness or when the solar panel output voltage is near zero. An embodiment includes a rubber plug to prevent water intrusion whenever the dummy DC Plug is removed. The DC plug opening also allows the battery voltage to be determined without disassembly of the illuminated street name sign. The DC plug can also be used to provide a quick charge to the battery system. Also not shown in FIGS. 8A-8C is an optional photocell port with a translucent or transparent window to prevent water intrusion. This optional photocell can be used to detect the onset of dusk when the LEDs 22 should be turned on or also the completion of night time hours when the LEDs 22 should be turned off.

Details regarding the control circuit which is used with the illuminated street name sign is now described. Initial tests using an initial version of the control circuit have indicated that the mA current per LED may range from about 7 mA at 3.0 VDC up to about 25 mA at 4.2 VDC. It appears that the optimum or near optimum LED light output brightness may occur at about 25 mA at the higher battery voltages between about 3.7 VDC and 4.2 VDC, and that the LED light output brightness decreases substantially as battery voltage drops below about 3.5 VDC. Accordingly, a relatively constant level of LED light output brightness and illumination can be provided to the translucent sign faces 10, during all the night time hours, regardless how much solar panel. 20, charging was earlier provided to the battery system. 74, during the previous daytime hours.

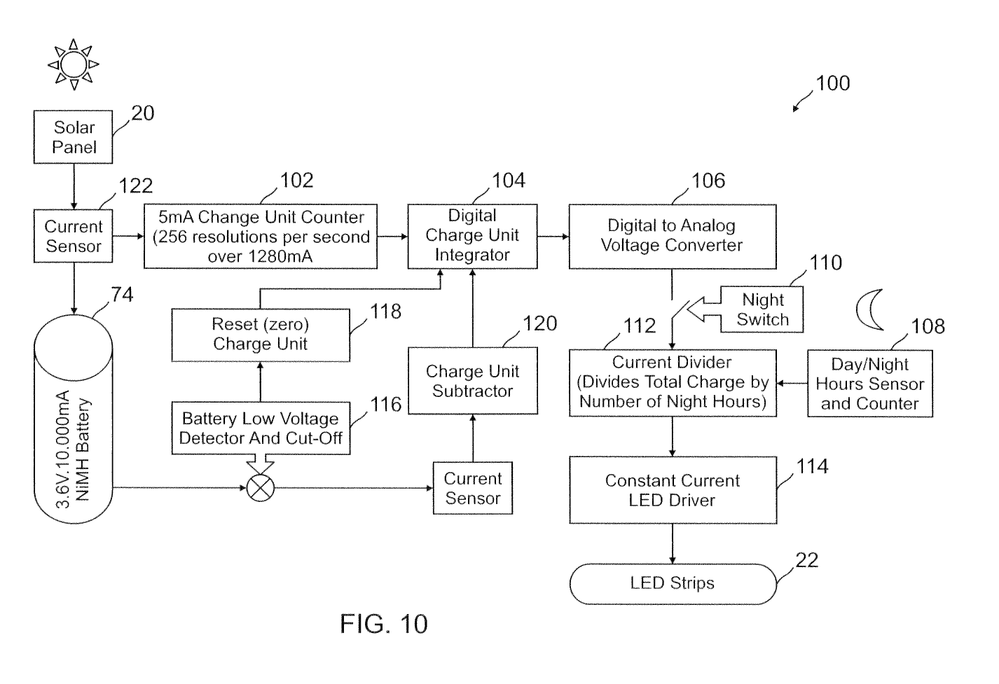

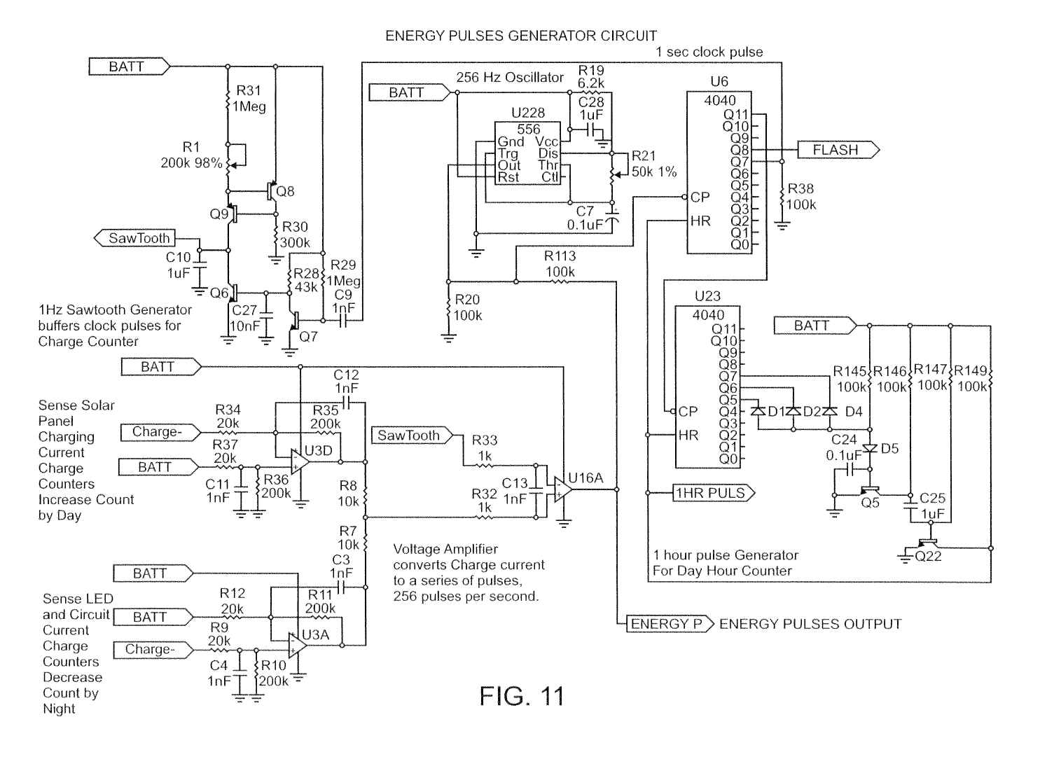

A block diagram showing an embodiment of the control circuit 100 used with the street name sign is shown in FIG. 10. Circuit diagrams of the components of the control circuit, which are described in detail below, are shown in FIGS. 11-18. The control circuit includes a charge unit counter 102 that counts the amount of solar energy being provided to the battery system 74, typically during each second of time, being provided to the battery system 74 from the solar panel 20. In one embodiment, the charge unit counter can record a count of charge at a resolution of 5 mA per unit within a total range of 256 charge units, resulting in a maximum charge per second of 1280 mA. i.e. 5 mA multiplied by 256 equals a maximum of 1280 mA. In one embodiment, the actual number of charge units recorded during each second is proportional to the amount of solar charge being supplied to the battery system 74 during this small time interval. Under hot and sunny weather conditions the charge unit counter may count near a maximum and on a rainy day with gray sky weather conditions, the charge unit counter may count much lower, which in one embodiment, may be typically about 15% to 25% of maximum, or about 200 mA to 320 mA during darkened sky or poor solar charging conditions.

The output from the charge unit counter is totalized by a digital charge unit integrator 104 to provide a signal output that represents all the solar energy provided to the battery system 74 during daytime hours. This signal is converted from a digital output to an analog output by a digital to analog voltage converter 106.

The LEDs 22 can provide relatively consistent illumination to the translucent sign faces 10 during all the night time hours, regardless of the weather conditions during the previous daytime hours. A day/night hour sensor and counter 108 keeps track of the total number of daytime hours based on either the solar panel output voltage or the optional photocell sensor output, which indicates ambient lighting conditions. The daytime hours are defined as the time interval during which the solar panel output to the battery system continues to remain higher than a predetermined threshold level. This can be determined either using an optional photocell sensor to detect the transition from day to night, or this can be determined whenever the solar panel output essentially drops to about zero mA. As soon as one of these indicators drops below the selected threshold level, the night hour counter is started and a night switch 110 is closed. The total number of night hours is determined by subtracting the total of the daytime hours from 24 hours per day/night cycle. A current divider circuit 112 then divides the total amount of battery charge provided to the battery system 74 during daytime hours by the total number of night time hours. The calculated result provides an output proportional to an optimized or near optimized level of mA current which may be consistently supplied to the LEDs 22 during all the night time hours. This calculation method allows the control circuit to regulate the light output brightness of the LEDs 22 to be provided at approximately a constant level of illumination brightness on the translucent sign faces 10 during all the night time hours. As the LEDs 22 are initially coming into operation, the digital charge unit begins to decrease the count of battery energy storage units, and then using the charge unit subtractor 120, the total number of integrated energy counts which have been collected during the previous daytime hours are subtracted from the total battery energy storage units. This enables the control circuit to keep track of the total amount of energy consumed by the LEDs 22 during all the night time hours. As soon as the solar panel output in mA to the battery system 74 (or the optional photocell sensor output), as measured by the current sensor 122 increases above the selected threshold level, the daytime hours begin again, and the night switch is opened, thereby starting the 24 hour day and night cycle once again. At this time, the digital charge unit integrator begins integrating once again to count the amount of solar energy being provided during each time interval (typically once per second) to the battery system 74 from the Solar Panel.

To illustrate the above control circuit operating process for a winter time day with only 8 hours of solar charging, the energy stored in the battery system 74 can be divided to enable the LEDs 22 to illuminate the translucent sign faces 10 for 16 hours of night time operation. For a summer time day with 16 hours of solar charging, the energy stored in the battery can be divided to enable the LEDs 22 to illuminate the translucent sign faces 10 for 8 hours of night time operation.

A constant current LED driver 114 maintains a relatively constant current to the LEDs as determined by the control circuit, except that the maximum current may be typically limited to a maximum of about 20 mA to 25 mA per LED to avoid over-driving the LEDs 22 and also to optimize or nearly optimize the utilization of any additional battery energy which has not yet been used up. During days with dark skies and adverse solar charging weather conditions, the amount of solar panel charge provided to the battery system 74 can be reduced, and therefore the LEDs 22, can continue to operate all during the night time hours, but with reduced illumination provided to the translucent sign faces 10.

When utilizing a 3.6 VDC battery that has a fully-charged voltage of about 4.2 VDC and a fully depleted voltage of about 2.7 VDC, the control circuit can also provide some additional safety features, such as causing the battery charging to stop when (a) battery voltage reaches a maximum of about 4.2 VDC, or (b) the battery reaches its maximum capacity as determined by the preset levels established by various mechanisms in the control circuit such as jumpers on the control circuit to avoid overcharging during the longer summertime hours or on sunny days. In addition, the control circuit can also modify the current consumption by the LEDs 22, as battery voltage decreases. For example, the light output from the LEDs 22, can optionally be reduced if battery voltage drops below about 3.2 VDC, and the LEDs 22, can also optionally be turned off if battery voltage drops below about 2.8 VDC. These battery cutoff features, which are realized by the battery low voltage detector and cut-off 116 provide higher long term reliability for the illuminated street name sign system. For example, if the LEDs 22, are turned off when battery voltage drops below about 2.8 VDC, then there is still sufficient battery charge remaining as needed to re-start the control circuit and solar panel charging cycle at the beginning of the next daytime hours. The charge unit counter is also reset to zero with the reset charge unit 118 at these reduced levels of battery voltage, and a new count unit total is started only at the beginning of the next series of daytime hours. The same type of control circuit can be utilized with different types of rechargeable batteries as well as batteries having different levels of rated DC voltage output. Minor adjustments to the control circuit could easily accommodate different battery voltage levels with different types of solar panel systems.

One of ordinary skill in the art will readily recognize that there are a variety of ways in which the control circuit block diagram in FIG. 10 can be designed to tit onto a printed circuit board (PCB) so as to fit easily into the bottom extrusion piece 50 or the end cap 60 of the illuminated street name sign. Details of an exemplary control circuit are provided in FIGS. 11, 12, 13, 14, 15, 16, 17 and 18. These eight figures are connected together to comprise the entire control circuit. These details have been separated into eight different circuit sections in order to describe the features of the control circuit with improved clarity.

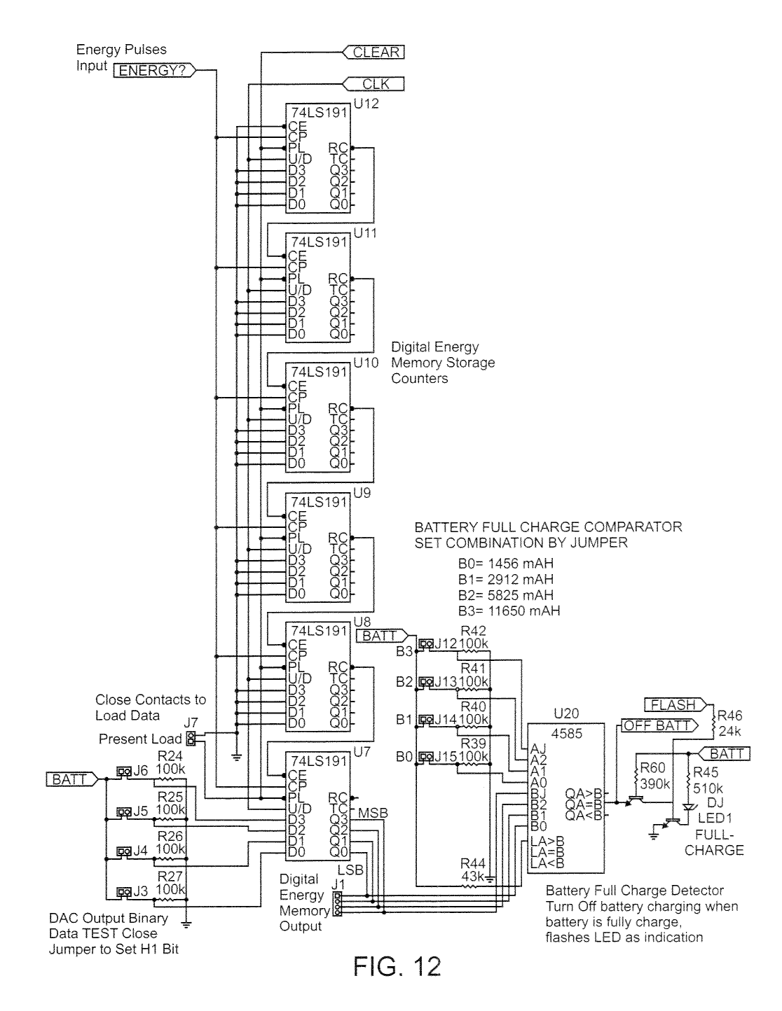

Turning now to FIG. 11, an exemplary energy pulse generator circuit is shown, which includes a pulse generator with an output of 256 pulses per second from a U22B Oscillator 556, which is an industry standard precision timer integrated circuit (IC). The two additional integrated circuits designated 4040 are marked U6 and U23. U6 provides pulses every 1 second and U23 provides pulses every 1 hour and these outputs are used to time the digital operation of the entire control circuit. The 1 second pulses from U6 are supplied to the sawtooth generator circuit on the left hand side of FIG. 11 to produce a 1 Hz sawtooth shaped waveform. These 1 Hz sawtooth pulses are used to measure the energy charge levels of current from the solar panel to the battery during daytime hours, which are amplified by operational amplifier U3D. During all the night time hours, the sawtooth pulses are used to measure the energy consumption levels of current from the battery to the LEDs, which are amplified by operational amplifier U3A. The number of pulses generated per second may vary in proportion to different levels of energy charge or energy consumption levels, with the maximum being 256 pulses per second, equivalent to 1280 mA of current flow. The energy pulse output is then provided to an exemplary digital energy storage circuit as shown in FIG. 12.

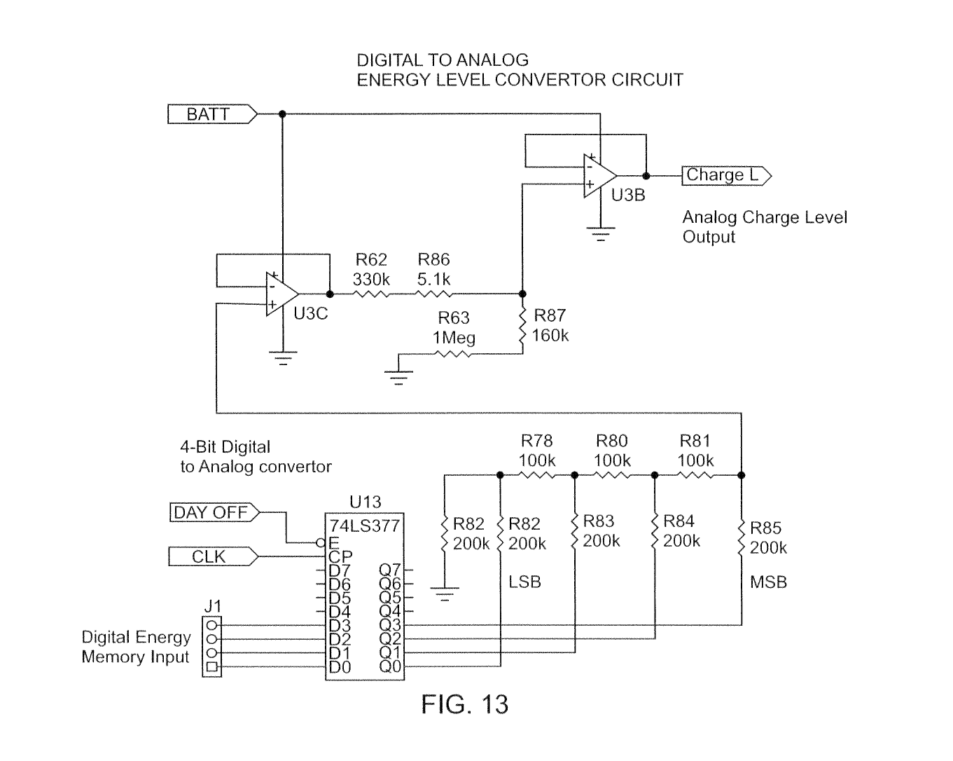

In FIG. 12, the ongoing stream of energy pulses is supplied to inputs of six integrated circuits (ICs) labeled U7 through U12 which are designated type 74LS191 or equivalent. These ICs are digital energy memory storage counters which keep track of solar panel energy supplied to the battery during daytime hours, and alternatively, keep track of battery power consumption by the LEDs during the night time hours. Four jumper contacts in FIG. 12 are labeled B0, B1, B2 and B3 which relate to jumpers J15 (for battery capacity of 1456 mAh), J14 (for battery capacity of 2912 mAh), J13 (for battery capacity of 5825 mAh) and J12 (for battery capacity of 11650 mAh). Once the energy storage capacity of the battery is known, the appropriate jumper can be installed to match with the energy storage memory capacity of the ICs labeled U7 through U12. At the right hand side of FIG. 12, there is also a battery charge detector circuit operating from the U20 integrated circuit designated 4585, which turns off any additional battery charging when the battery becomes fully charged and also starts the D3 LED to start blinking to indicate full charge has been reached. Test and reset jumpers J3 through J6 are provided on the left hand side of FIG. 12 and are used when the control circuit is first being started up. The output from the circuit of FIG. 12 is supplied as input to FIG. 13 through the four connections labeled digital energy memory output and labeled in FIG. 13 as digital energy memory input.

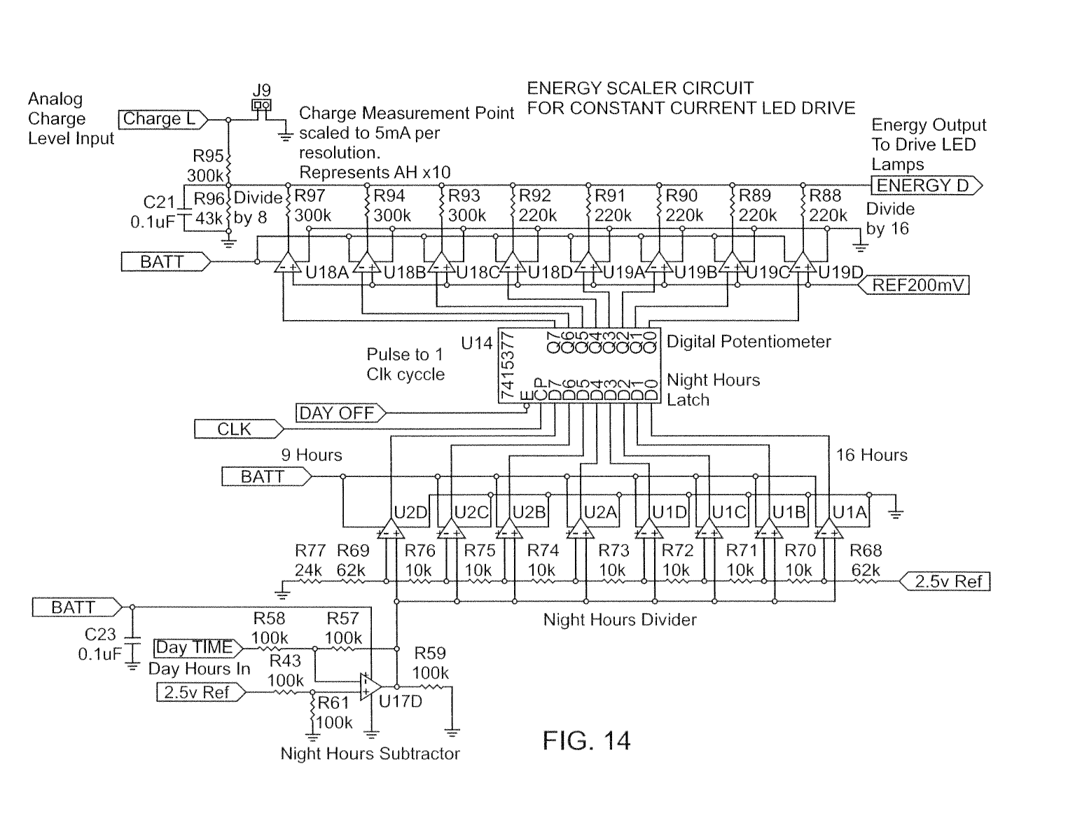

FIG. 13 is an exemplary circuit which converts the digital energy memory input from digital to analog format. The digital input is provided to integrated circuit U13 labeled 74LS377 and converted to an analog output voltage supplied from operational amplifiers U3C and U3B. This analog charge level input signal is passed onwards to an exemplary energy scaler circuit in FIG. 14.

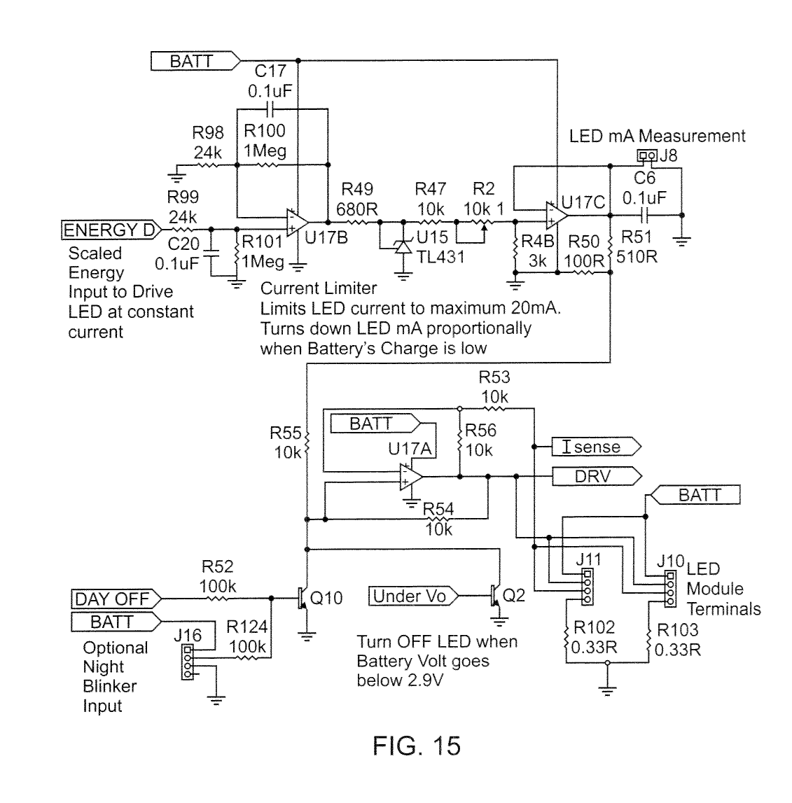

FIG. 14 shows the exemplary energy scaler circuit which is used to subtract the daytime hours from 24 hours per day to determine the night time hours during which the LEDs should operate at a constant level of current consumption as supplied from the battery. The daytime hour signal is provided to the subtracting circuit in the lower left hand corner of FIG. 14. The night time hours that are to be utilized is calculated using operational amplifier U17D which provides an output to the eight operational amplifiers labeled U1A to U1D and U2A to U2D which provide discrete night time hour input signals to integrated circuit U14 labeled 74LS377. U14 then provides discrete night time output signals to eight additional operational amplifiers labeled U18A to U18D and U19A to U19D. These eight operational amplifiers then provide a corrected energy output signal which is scaled to match with the available energy stored in the battery during the previous daytime hours. This corrected energy output signal is then used by an exemplary LED driver circuit in FIG. 15 to adjust the current supplied for driving the LEDs at the correct level of current consumption during all the night time hours. The exemplary circuit of FIG. 14 can evenly divide the night time hours required for LED operation and scale the output signal to match with the available battery energy that has previously been stored during the daytime hours and provided to the scaler divider circuit in the form of the analog charge level input signal provided from the circuit of FIG. 12.

FIG. 15 is the exemplary LED driver circuit, which adjusts the voltage output signal from the energy scaler circuit so that none of the LEDs operate at more than approximately 20 mA or alternatively 25 mA per LED, which could overdrive the LEDs and cause early failure. All during the night time hours, the LED driver circuit continues to provide battery power to operate the LEDs at a constant level of current consumption. The LEDs are connected to the LED driver circuit through jumpers J10 and J11 located at the lower right hand corner of FIG. 15. If the battery voltage decreases down to 3.0 VDC due to power consumption by the LEDs, then the LED driver circuit turns down the current consumption by the LEDs regardless the input from the scaler energy circuit to extend the LED operating time. If the battery voltage continues to decrease down to below about 2.8 VDC, the transistor Q2 turns off the LEDs to conserve some of the battery energy and avoid over-discharging the battery.

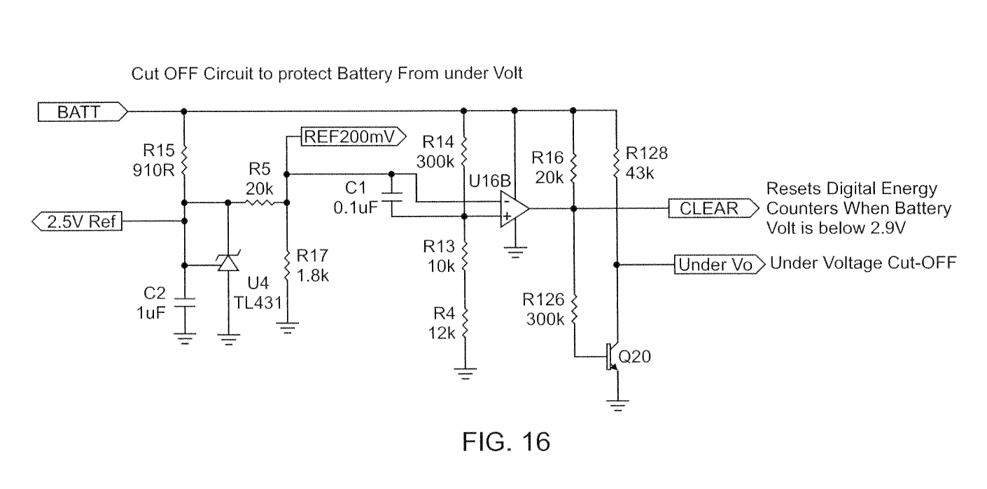

FIG. 16 further illustrates the battery protection features of the control circuit. An exemplary under voltage protection circuit shown in FIG. 16 uses operational amplifier LT16B and compares the battery voltage to a reference voltage. In the event the battery voltage drops to less than about 2.8 VDC, transistor Q20 turns off the LED driver circuit, which turns off the LEDs. Also, the digital energy storage circuit as shown previously in FIG. 12 is reset to zero, so the energy storage parameter starts from zero whenever the solar panel again begins recharging the battery.

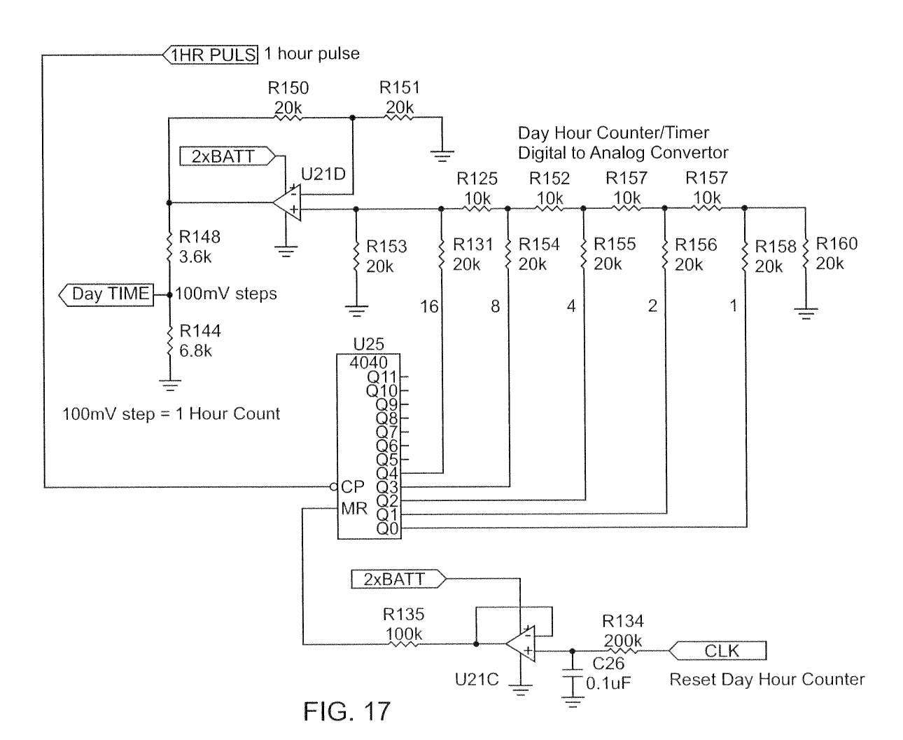

FIG. 17 is an exemplary day hour counter circuit, which counts the number of daytime hours as supplied from the 1 hour pulse generator as described from the circuit of FIG. 11. This 1 hour digital pulse signal is supplied to integrated circuit U25 labeled 4040 and the digital output from this integrated circuit is converted to an analog signal output using operational amplifier U21D, The analog output signal from U21D is provided to the energy scale circuit in FIG. 14 at the lower left hand side, where this analog signal representing the daytime hours is used for calculating the total night time hours by subtracting from 24 hours per day using operational amplifier U17D. The day hour counter is also reset to zero at the beginning of each night time hour cycle.

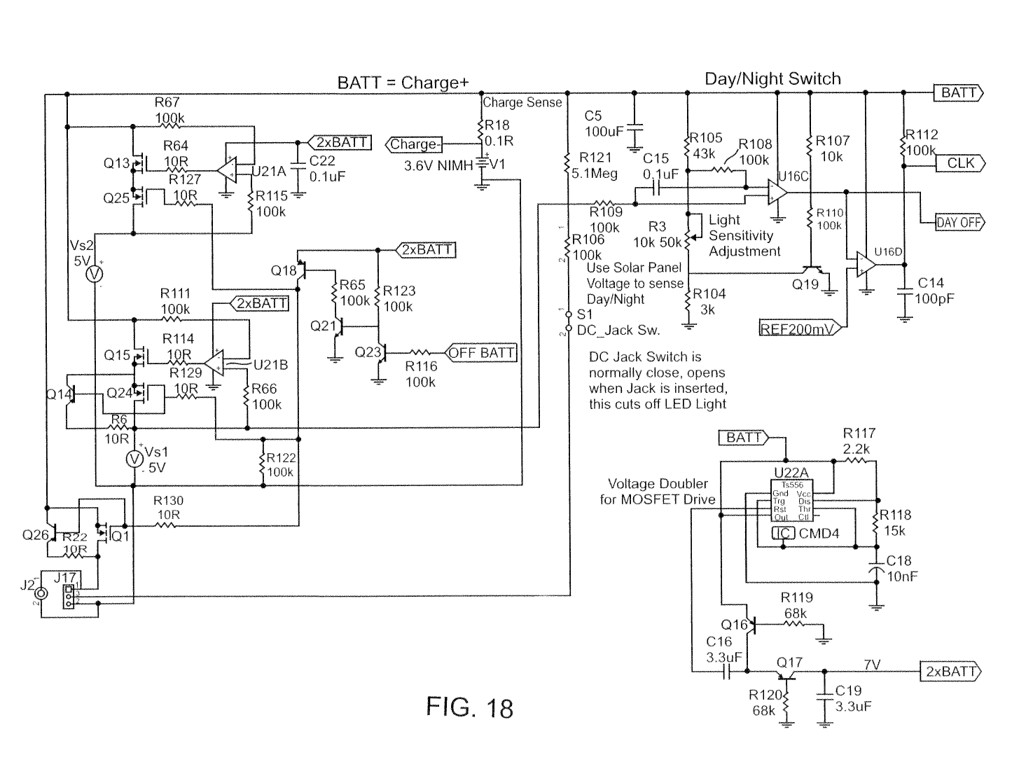

FIG. 18 shows an exemplary day-night auto switch circuit which determines the end of the daytime hours and the start of the night time hours when the voltage output from the Solar Panel drops to approximately zero. In this circuit, the output voltages from the 5 VDC solar panels Vs1 and Vs2 are provided to a sensitive circuit of metal oxide substrate field effect transistor switches (or MOSFETs) and operational amplifiers which detect the transitions from daytime hours to night time hours and vice-versa. For example, at dusk, the voltage output from the solar panel system drops to nearly zero, thereby triggering the sensitive detector circuit. At the same time, the day-night Switch represented by operational amplifier U16C provides an output indicating that the daytime hours have been completed, and the night time hours are beginning. Conversely, at dawn when the solar panel system voltage rises about a level of nearly zero, the day-night switch reverts to solar charging supplied to the battery during the daytime hours. The response sensitivity of U16C can also be adjusted using the rheostat R3 as desired.

FIG. 18 also shows an exemplary solar charging ON-OFF control circuit that switches off battery charging as described above with respect to FIG. 12 on the left hand side of the circuit. MOSFET transistor switches Q24 and Q25 turn off whenever the total charge contained in the battery reaches its maximum capacity.

In addition, to enable the battery to receive electrical charging from the solar panel during periods of low sunlight (such as during gray or overcast sky conditions), an exemplary unidirectional current flow zero-volt turn on circuit, which is shown in FIG. 18, is provided in the place of a conventional Schottky diode between the solar panel and the battery. The unidirectional current flow zero-volt turn on circuit includes a voltage comparator operational amplifier U21B, combined with resistors R111, R66 and R114, which provide an output to MOSFET transistor switch Q15. The MOSFET transistor switch Q15 then operates to turn on with extremely low resistance whenever the output voltage from the solar panel Vs1 is higher than the battery voltage. The forward voltage drop across MOSFET transistor switch Q15 is typically less than about 0.1 V. This is significantly less than the forward voltage drop of a Schottky diode, which is typically about 0.4 V. During the night time hours. MOSFET transistor switch Q15 turns off to prevent the battery from discharging through the solar panel Vs1. A similar circuit consisting of voltage comparator operational amplifier U21A, combined with resistors R67, R115 and R64, operate together to provide an output to MOSFET transistor switch Q13. MOSFET transistor switch Q13 operates in conjunction with solar panel Vs2 and the battery as previously described for MOSFET transistor switch Q15 to enable battery charging during periods of low sunlight conditions and to prevent battery discharging backwards through the solar panel during all the night time hours. The exemplary circuit shown on the left hand side of FIG. 18 operates during long overcast days or during the winter season months when the solar panel can only provide charge to the battery system 74 based on low levels of sunlight or poor solar charging conditions.

The exemplary circuit surrounding integrated circuit U22A, labeled TS556, at the lower right hand of FIG. 18 is a voltage amplifier that supplies the working voltage required for the proper operation of the MOSFET transistor switches which provide the ON-OFF control of battery charging from the solar panel, as has been described above. The control circuit according to various embodiments may also include several additional adjustment features located on the PCB itself, which may include the following items:
1. Various jumpers are provided to be used to determine the capacity of the battery system, 74.
2. A red LED is provided which blinks when the battery system, 74, is fully charged.
3. A sensitivity adjustment rheostat is provided and used for setting the optional photocell sensor output based on ambient light at the desired threshold level.
4. An auxiliary rheostat is also used for adjusting the maximum LED light output brightness.
5. A DC Jack which can be used externally to (a) measure the battery voltage, or (b) provide a quick charge to the battery, or (c) diagnose battery voltage during solar charging conditions (in daytime) or LED discharging conditions (at night).
6. A dummy DC Plug can be installed into the DC Jack which disconnects the Control Circuit during storage. This also maintains sufficient battery charge for startup after installation.
7. Several miniature polarized DC Plugs and DC Jacks are provided along with the required connecting wires for interconnecting the various solar panels, batteries, and LEDs, as well as the required connections back and forth between these components and the control circuit.
8. Test points on the control circuit PCB are provided for measuring the charge current being supplied from the solar panel to the battery, and also for measuring the total current being supplied from the control circuit to the LEDs 22.

As described above. FIG. 4 shows the illuminated street name sign mounted to a post or pole or wall using conventional cantilever mounting brackets to provide a secure and vandal-resistant mounting system.

Another method for providing a secure and vandal-resistant mounting to the top of a post or pole includes using a central rod with a threaded nut which can be tightened which is located at the top of the central rod. To maintain the proper distance between the top and bottom extrusion pieces when the top nut is tightened, a tube of suitable length is installed between the top and bottom extrusion pieces to ensure that the top and bottom extrusion pieces do not move closer together as the top nut is tightened. Also, the top portion of the post or pole is covered with a suitably-sized cap that can be firmly secured to the post or pole using fasteners, set screws, or the like, which are attached from the sides in one or more places, as appropriate. Also, the bottom section of the central rod has at least one or more disks attached which slide into the inside diameter of the post or pole, and provide additional support and rigidity and help to resist vandalism of the illuminated street name sign.

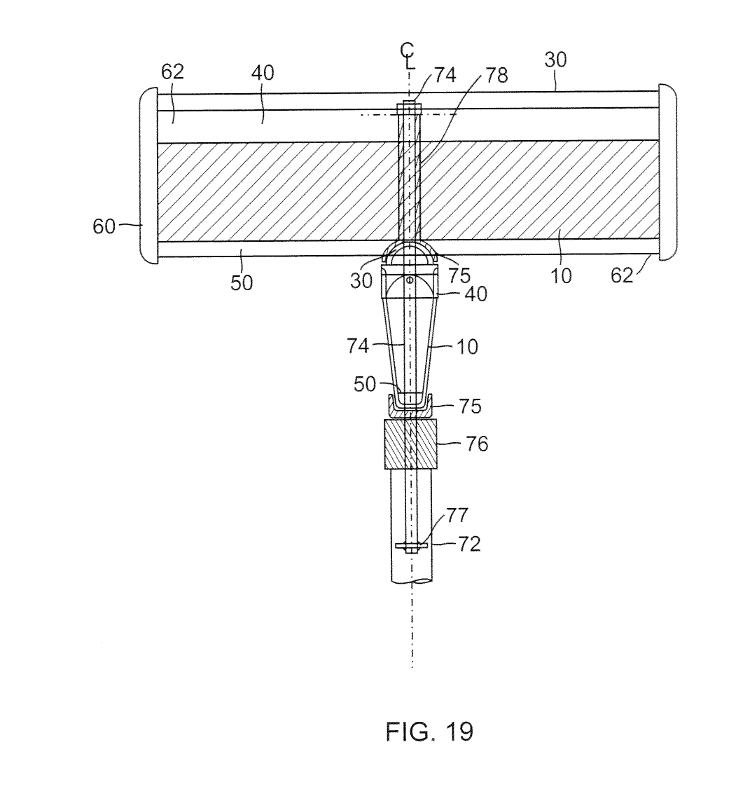

The above-described features are illustrated in FIG. 19, which shows the overall design of the mounting system. As seen in FIG. 19, there are two illuminated street name signs which are attached at right angles to each other using the cross-connection piece 75, so that the street names are indicated at an appropriate cross-street location. This arrangement includes a cross-connection insert piece 75 located on the top extrusion piece of the bottom-mounted illuminated street name sign. The cross-connection insert piece 75 is shaped to receive the bottom extrusion piece 50 of the upper illuminated street name sign and is securely screwed into the top extrusion piece 40 of the bottom illuminated street name sign. Accordingly, the two illuminated street name signs remain at right angles to each other to indicate the street names at any suitable cross-street location.

In FIG. 19, the cross-connection insert piece 75 is shown in two different locations, one where the two illuminated street name signs are cross-connected at right angles to each other, and another on top of the post 72, where another cross-connection insert piece 75 is bolted or welded to the post cap 76. These cross-connection insert pieces 75 show how the right angle positioning of the two illuminated street name signs can be maintained after the top nut is tightened at the top of the threaded central rod 74. A tubular sleeve 78 that fits over the central rod 74 maintains a desired distance between the inside of the top cap piece 76 and the uppermost bottom disk piece 77, as the central rod 74 is tightened against the top cap piece 76 using the top nut on the central rod 75. The bottom-most disk 77, is located lower than the uppermost bottom disk, 77, and acts against the inside surfaces of the pole or post 72 to counterbalance bending forces imposed by the solar traffic name sign assembly during high wind or vandalism conditions.

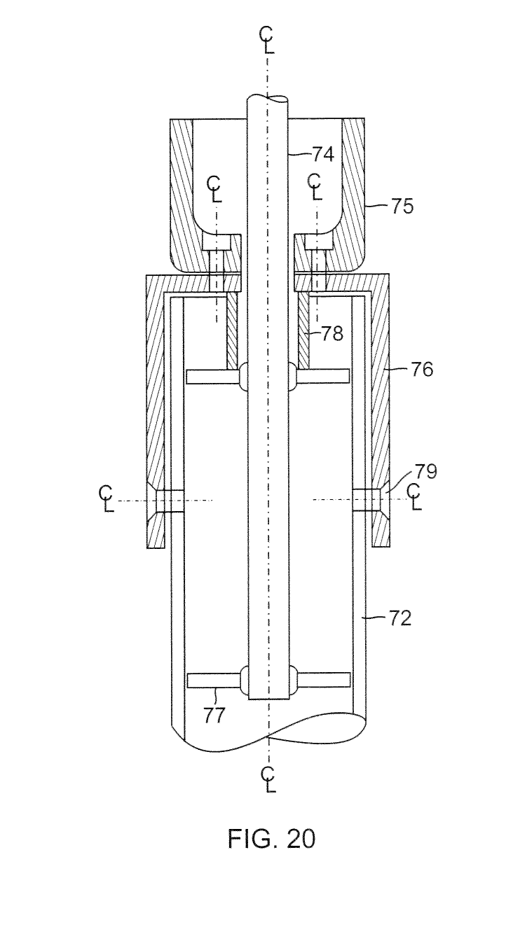

FIG. 20 shows a more detailed view of the internal portion of the bottom section of the central rod 74 with the one or more attached upper and lower internal disks 77, which are configured to fit in the inside diameter of the post or pole 72. A short section of tube 78 fits over the outer diameter of the central rod 74 and allows the one or more disks 77 to engage the inner diameter of the post or pole 72 at a suitable distance below the top of the post or pole 72, so that there is sufficient rigidity of the central rod 74 to support the illuminated street name sign mounted above. The top cap 76 is attached securely to the top of the post or pole 72 using several side-mounted set screws 79. These set screws 79 are threaded into the side walls of the post or pole 72. FIG. 20 also shows that mounted on top of the top cap 76 is a cross-connection piece 75 that is configured to receive the bottom extrusion piece 50 and hold it securely in place. This cross-connection piece 75 can be bolted or welded to the top cap 76 as appropriate. As shown in FIG. 20, the cross-connection piece 75 is shown as being bolted to the top cap 76.

Other embodiments are described below. One embodiment is a street name sign equipped with a solar photovoltaic panel system and which is illuminated during all the night time hours with a control circuit which collects and measures the solar energy distributed to the battery system during the previous daytime hours, and calculates how much electrical energy can be provided to the one or more LEDs during all the upcoming night time hours to thereby provide relatively constant LED light output and relatively uniform night time illumination of the one or more translucent sign faces on the street name sign.

Another embodiment relates to the arrangement of the one or more LEDs located inside the solar powered illuminated street name sign so that the illumination of the one or more translucent street name sign faces is relatively uniform and does not contain significant light and dark areas on the visible sign faces. To accomplish this, the one or more LEDs are arranged in a linear line and the light output from the line of LEDs is aimed horizontally towards a curved reflective surface wherein the reflected LED light is directed downwards more or less uniformly across the inside face of the translucent street name sign. For example, if the solar powered illuminated street name sign has translucent faces aimed towards motor vehicle traffic coming from both directions on the adjacent roadway, then there are two opposing sign faces. In this case, it is preferred that there are two linear rows of LEDs which both are aimed horizontally outwards away from each other towards two curved reflective surfaces so that the LED light from each row of LEDs is directed downwards along both of these translucent sign faces. The curved reflective surfaces may include Alanod Miro 7 aluminum sheet material (or similar reflective material) which can be formed to the desired curvature to provide relatively uniform LED illumination of the translucent sign faces, such that the brightest areas are not more than three times brighter than the dimmest areas. A wide variety of similar reflective materials can be used in place of the Alanod Miro 7 aluminum.

Another embodiment is to position the solar panel system at the top of the illuminated street name sign with the solar photovoltaic panels aimed approximately vertically upwards and protect the solar panel system with a rounded transparent plastic cover which prevents water or debris from collecting on the solar panels. The translucent sign faces may be angled slightly downwards towards oncoming traffic for better visibility, with the angle being between about 5 and 15 degrees tilted away from the vertical direction, with approximately 10 degrees tilted away from the vertical direction being considered optimum. Accordingly, the bottom extrusion piece will be narrower than the top extrusion piece. The translucent sign faces will then normally be mounted between these two extrusion pieces and secured by attaching the end caps with suitable screws to the sidewalls of the top and bottom extrusion pieces to provide for mechanical strength.

Another embodiment involves the use of a central rod, threaded on top to receive a tightening nut, wherein the top and bottom extrusions are held apart at a pre-determined distance as the nut is tightened. The threaded rod also includes at least one or more internal disks which are passed into the inside diameter of the pole or post, such that the threaded rod mounting system is secured into the topmost portion of a pole or post to provide a relatively vandal-proof mounting system. Another method would be to utilize cantilever mounting to the sidewall of any type of pole or post as shown in FIG. 4.

The present method, apparatus and system can be used for almost any size of solar-powered illuminated street name sign. Typically, street name signs having sizes from as small as 6×12 inches up to 9×48 inches may be commonly utilized. However, the actual size of the illuminated street name sign can be much larger or much smaller according to the preference of the designer and the intended usefulness for any particular type of application.

The above description presents the best mode contemplated for methods, apparatuses and systems for a street sign having constant LED night brightness based on daytime solar charging, in such full, clear, concise, and exact terms as to enable any person skilled in the art to which it pertains to make and use these types of illuminated street signs. The methods, apparatuses and systems described herein, however, are susceptible to modifications and alternate constructions from that discussed above that are equivalent. Consequently, the methods, apparatuses and systems described herein are not limited to the particular embodiments disclosed. Furthermore, features, aspects, or functions specifically discussed for one embodiment but not another may similarly be incorporated in the latter provided the features, aspects and/or functions are compatible. Thus, the disclosure covers all modifications and alternate constructions coming within the spirit and scope of the disclosure as generally expressed by the following claims, which particularly point out and distinctly claim the subject matter of the disclosure.

What is claimed is:

1. A street sign comprising:
at least one translucent sign face;
a solar photovoltaic panel system;
a rechargeable battery system;
at least one Light Emitting Diode (LED);
a control circuit powered by the rechargeable battery system and configured to operate the at least one LED to illuminate the at least one sign face;
wherein the rechargeable battery system receives electrical power from the solar photovoltaic panel system during daytime; and
wherein the control circuit is configured to monitor the total amount of solar energy supplied to the rechargeable battery system during daytime and configured to calculate an amount of electrical power to be supplied from the rechargeable battery system to the at least one LED so that the at least one LED operates at a relatively constant level of LED light output brightness during substantially all the entire night time hours.

2. The street sign of claim 1, wherein the at least one translucent sign face comprises a street name or informational lettering which is illuminated from an inside surface of the translucent sign face by the at least one LED.

3. The street sign of claim 1, further comprising at least one curved reflecting surface, wherein the light output from the at least one LED is directed towards the at least one curved reflecting surface, wherein the at least one curved reflective surface reflects and distributes the light from the at least one LED substantially uniformly in a downward direction across the inside surface of the at least one translucent sign face, thereby illuminating the sign face from the inside to thereby become more visible as viewed from the outside of the sign face by motor vehicles approaching from nearby roadways or streets.

4. The street sign of claim 3, wherein the at least one curved reflecting surface has a curvature that provides relatively uniform LED reflected light for illumination of the inside surfaces of one or more translucent sign faces, such that brightest areas of the illuminated sign face are not more than about three times brighter than dimmest areas of the illuminated sign face as viewed from outside of the sign face by motor vehicles approaching from nearby roadways or streets.

5. The street sign of claim 4, wherein the at least one curved reflective surface is comprised of Alanod Miro 7 aluminum sheet material or similar reflective aluminum sheet material.

6. The street sign of claim 1, wherein the at least one translucent sign face is angled away from a true vertical direction between about 5 degrees to 15 degrees such that the at least one sign face is aimed substantially directly towards oncoming motor vehicle traffic.

7. The street sign of claim 1, further comprising a top extrusion piece, a bottom extrusion piece and two end caps attached to the top and bottom extrusion pieces, wherein the solar photovoltaic panel system comprises at least one solar panel mounted on the top extrusion piece and aimed upwards.

8. The street sign of claim 7, further comprising a transparent cover configured to protect the at least one solar panel.

9. The street sign of claim 8, comprising two translucent sign faces mounted between the top and bottom extrusion pieces, and wherein the sign faces are enclosed and mechanically strengthened when the end caps are attached to the top and bottom extrusion pieces using suitable mechanical screws or an equivalent attachment method.

10. The street sign of claim 8, wherein the rechargeable battery system is located underneath the at least one solar panel.

11. The street sign of claim 1, wherein the control circuit comprises an energy pulses generator circuit configured to provide pulses for detecting a rate of energy discharge transfers between the at least one solar panel and the rechargeable battery system during daytime and between the rechargeable battery system and the at least one LED during night time.

12. The street sign of claim 1, wherein the control circuit comprises a digital energy storage circuit configured to record and totalize a quantity of energy transfers between the rechargeable battery system and the solar panel during daytime and between the rechargeable battery system and the at least one LED during night time.

13. The street sign of claim 1, wherein the control circuit comprises an energy digital to analog converter circuit configured to convert a digital signal from an energy storage circuit to an analog signal.

14. The street sign of claim 1, wherein the control circuit comprises an energy scalar circuit is configured to determine the hour duration of an upcoming night time sequence and configured to scale a quantity of energy stored in the rechargeable battery system during the previous daytime to enable the at least one LED to operate all during the night time hours at a relatively constant level of LED light output brightness.

15. The street sign of claim 1, wherein the control circuit comprises an LED driver circuit configured to provide stored electrical energy from the rechargeable battery system to the at least one LED, configured to prevent overdriving of the at least one LED, and also configured to decrease the LED brightness when the a voltage supplied from the rechargeable battery system drops below a predetermined voltage level.

16. The street sign of claim 1, wherein the control circuit comprises an under voltage protection circuit configured to shut off operation of the at least one LED when a voltage from the rechargeable battery system drops below a predetermined voltage level.

17. The street sign of claim 1, wherein the control circuit comprises a day hour counter circuit is configured to use pulses provided by an energy pulses generator circuit to count a total duration of daytime hours and calculate an output signal that is provided to an energy scalar circuit so that the duration in hours for an upcoming night time can be calculated.

18. The street sign of claim 1, wherein the control circuit comprises a day-night auto switch circuit configured to determine a transition event between day and night at dusk or night and day at dawn using an output provided from the at least one solar panel.

19. A street sign system comprising:
a post or pole;
at least one street name sign mounted to the post or pole, the street name sign comprising:
at least one translucent sign face;
a solar photovoltaic panel system;
a rechargeable battery system:
at least one Light Emitting Diode (LED):
a control circuit powered by the rechargeable battery system and configured to operate the at as one LED to illuminate the at least one sign face;
wherein the rechargeable battery system receives electrical power from the solar photovoltaic panel system during daytime; and
wherein the control circuit is configured to monitor the total amount of solar energy supplied to the rechargeable battery system during daytime and configured to calculate an amount of electrical power that can be supplied from the rechargeable battery system to the at least one LED so that the at least one LED operates at a relatively constant level of LED light output brightness during substantially all the entire night time hours.

20. The street sign system of claim 19, further comprising:
a central rod having a top portion configured to receive a fastener;
a spacer tube surrounding the central rod;
the street name sign comprising a top extrusion piece and a bottom extrusion piece:
wherein the street name sign is mounted to a top portion of the post or pole using the central rod with the fastener such that when the fastener is tightened, the top and bottom extrusion pieces are clamped against the spacer tube, and wherein the spacer tube maintains a predetermined distance between the top and bottom extrusion pieces.

21. The street sign system of claim 20, further comprising a top cap secured to the post or pole with fasteners and covering the top of the post or pole, and the central rod comprising at least one internal disk configured to slide into an inside diameter of the post or pole.

22. The street sign system of claim 21, further comprising at least an additional spacer tube configured to provide additional space between the at least one internal disk and an inside of the top cap.

23. The street sign system of claim 19, further comprising at least another street name sign mounted to the post or pole and a connection piece configured to mount these two street name signs at a pre-determined angle relative to each other.

24. A method of illuminating a street sign comprising:
generating electrical energy during a day with a solar photovoltaic panel system receiving sunlight;
storing the generated electrical energy in a rechargeable battery system;
powering at least one light emitting diode (LED) during substantially all the night time hours that follow the day time charging hours by utilizing the electrical energy stored in the rechargeable battery system; and
wherein the at least one LED illuminates at least one translucent sign face.

25. The method of claim 24, further comprising:
providing a relatively constant level of light output with the at least one LED during all the night time hours;
directing the light output from the at least one LED towards at least one curved reflective surface; and
wherein the light output is reflected downwards across an inside surface of the at least one translucent sign face such that a brightest area of sign face illumination does not exceed about three times the brightness of a dimmest area of sign face illumination as viewed from outside the at least one sign face by motor vehicles approaching from nearby roadways or streets.

26. The method of claim 24, further comprising:
performing a first calculation of a total amount of solar charging electrical energy supplied to the rechargeable battery system during the entire previous daytime hours;
performing a second calculation to determine an optimum or near optimum level of electrical current to be provided to the at least one LED from the rechargeable battery system during substantially all the night time hours based on the first calculation; and
providing a relatively constant level of sign face illumination during all the night time hours based on the second calculation.

27. The method of claim 24, further comprising powering a plurality of LEDs, wherein the LEDs comprise white colored LEDs with a size of about 5 mm diameter, having a rating of at least about 1500 millicandella when operated at 20 mA current, and having a surface brightness of about 100 Lux.
